(19) United States
(12) Patent Application Publication
(10) Pub. No.: US 2026/0326843 A1
(43) Pub. Date: Oct. 22, 2026

(54) VEHICLE GLASS MOUNTING DEVICE

(71) Applicant: TOSYS Co.,Ltd., Incheon (KR)

(72) Inventor: SANG PILL KIM, Incheon (KR)

(21) Appl. No.: 19/109,643

(22) PCT Filed: Aug. 10, 2023
(86) PCT No.: PCT/KR2023/011797

§ 371 Date: Mar. 7, 2025

(30) Foreign Application Priority Data
Oct. 14, 2022 (KR) 10-2022-0132128

(51) Int. Cl. B62D 65/02; B25J 9/16; B25J 15/06; B25J 19/06; B62D 65/06

(52) U.S. Cl. CPC B62D 65/026; B25J 15/0616; B25J 19/06; B62D 65/06; B25J 9/1687

(57) ABSTRACT

A glass mounting device includes a frame unit to be coupled to an end of an arm of a robot for installing a glass for a vehicle, a plurality of suction holders provided on the frame unit, the plurality of suction holders configured to vacuum-suction and hold the glass, a robot detection unit configured to detect whether a malfunction has occurred in the robot, and an emergency avoidance unit configured to move the glass, which is suctioned by the suction holders, outside a collision range with a body of the vehicle to prevent a collision when the malfunction occurs in the robot. If a malfunction occurs in the robot during the glass mounting process, the emergency avoidance unit allows the glass to be immediately retracted outside the collision range with the vehicle body.

### BACKGROUND

### 1. Technical Field

The present invention relates to a vehicle glass mounting device.

More specifically, it relates to a vehicle glass mounting device that enables the automatic installation of glass by a robot, while effectively preventing collisions between the glass and the vehicle body even in the event of a malfunction in the robot, during glass installation while tracking the movement of the vehicle body,

### 2. Background Art

In general, vehicle production includes numerous assembly processes. Among them, the glass mounting process involves installing glass (windshields) onto the front and rear glass mounting sections of the vehicle body.

Traditionally, in the glass mounting process, vehicles are fed into the assembly line at fixed intervals, and workers manually install the glass onto the designated mounting sections. This manual process results in increased worker fatigue, prolonged production time, higher labor costs, decreased productivity, and inconsistent fastening quality.

Accordingly, to address the issues of manual work as mentioned above, technology is being researched to enable a robot arm with a glass suction mechanism to perform tracking movements of the vehicle body and automatically install the glass.

However, in the case of automatic installation, a significant issue arises in that, if a robot malfunctions, the risk of a collision between the glass and the vehicle body is high. To date, an effective solution to this issue has not been proposed.

### SUMMARY

The present invention has been proposed to solve the problems of the related art described above, and an object of the present invention is to provide a vehicle glass mounting device capable of efficiently preventing collisions between the glass and the vehicle body by enabling emergency avoidance movement of the glass outside the collision range when a robot malfunction occurs.

As a solution of the present invention to achieve the object described above,
there is disclosed a vehicle glass mounting device including:
a frame unit coupled to the end of a robot arm; a plurality of suction holders installed on the frame unit to vacuum-suction and hold the glass; and an emergency avoidance unit that moves the glass, which is suctioned by the suction holders, outside the collision range with the vehicle body to prevent a collision when a malfunction occurs in the robot.

According to the present invention, if a malfunction occurs in the robot during the glass mounting process, the emergency avoidance unit allows the glass to be immediately retracted outside the collision range with the vehicle body. As a result, the risk of collisions between the glass and the vehicle body due to a robot malfunction is effectively eliminated.

By preventing such collisions, the automated installation process, where the robot tracks the movement of the vehicle body and installs the glass, can be implemented in a stable and efficient manner while maintaining the vehicle body's movement along the assembly line.

### BRIEF DESCRIPTION OF THE DRAWINGS

FIG. 1 is a perspective view illustrating an example of a vehicle glass mounting device according to the present invention.

FIG. 2 is a perspective view from the bottom side illustrating an example of the vehicle glass mounting device according to the present invention.

FIG. 3 is a diagram illustrating the vehicle glass mounting device in the direction of A in FIG. 1.

FIG. 4 is a diagram illustrating an example of how the vehicle glass mounting device according to the present invention is coupled to the arm of a robot for operation.

FIG. 5 is an enlarged view illustrating a major part of FIG. 4.

FIG. 6 is a diagram illustrating an example of the vehicle glass mounting device holding the glass during normal robot operation.

FIG. 7 is a diagram illustrating an example of the vehicle glass mounting device when the emergency avoidance unit is activated due to a robot malfunction.

FIG. 8 is a diagram illustrating an example of the emergency avoidance unit preventing a collision by retracting the glass outside the collision range when a robot malfunction occurs.

### DETAILED DESCRIPTION

Hereinafter, an exemplary embodiments of the present invention will be described in detail with reference to the accompanying drawings.

The shape, size, number, and spacing of elements in the attached drawings may be reduced or exaggerated for clarity, and unless otherwise specified, the invention is not limited to the aspects depicted in the drawings.

Additionally, directional terms such as front, rear, left, right, top, and bottom used in the drawings and descriptions are based on the perspective in which the drawings are viewed. Therefore, these terms may vary depending on the observer's viewpoint.

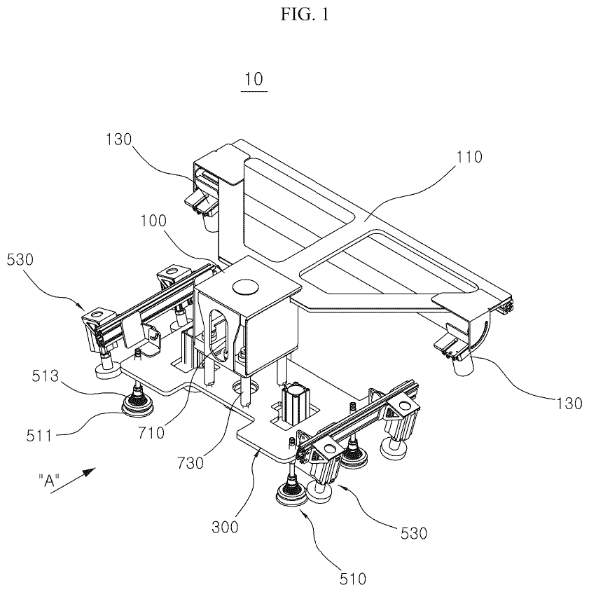

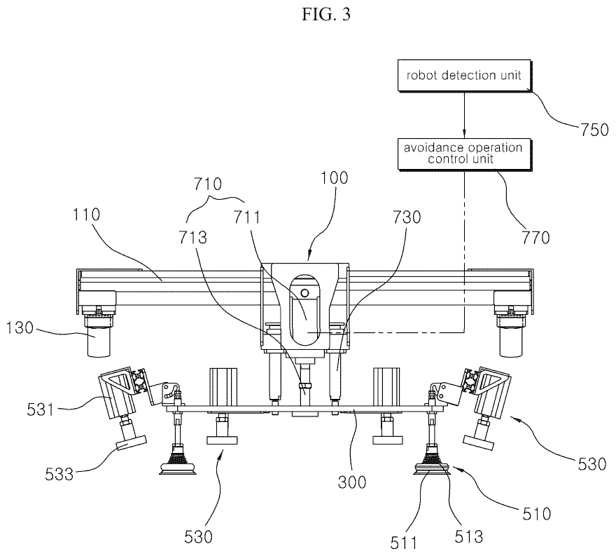

FIG. 1 and FIG. 3 illustrate an example of a vehicle glass mounting device according to an embodiment of the present invention.

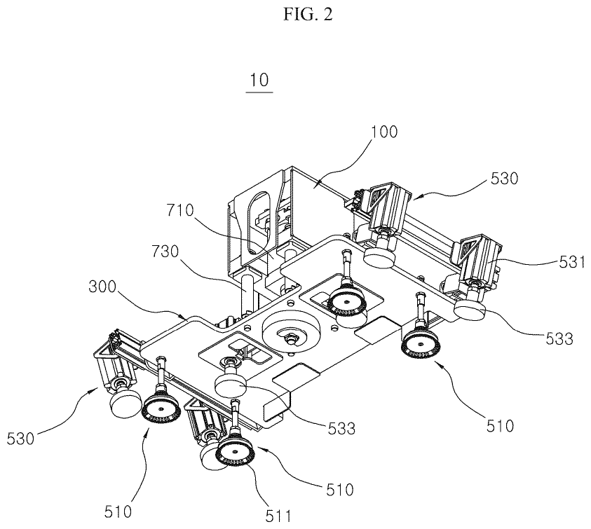

As illustrated in FIGS. 1 to 3, the vehicle glass mounting device 10 according to one embodiment of the present invention may include a frame unit 100, 300, a suction holder 510, a pressing presser 530, and an emergency avoidance unit.

The frame unit 100, 300 is a structural component for installing the components of the present invention and is coupled to the end of a robot R arm. For example, the frame unit may include a mounting frame 100 and a jig frame 300, which are separable from each other.

The mounting frame 100 is the part fixed to the end of the robot R arm, specifically arranged in the glass mounting process line of the vehicle assembly line.

In other words, the mounting frame 100 is fixed to the end of the robot R arm. Accordingly, the position and orientation of the mounting frame 100 may vary based on the movement of the robot R arm.

Here, the robot R may be an articulated robot with multiple axes, capable of tracking the displacement of the vehicle body C and operating along a programmed control path.

Depending on the embodiment, the mounting frame 100 may further include a vision frame section 110 extending a certain length to one side.

The vision frame section 110 may be equipped with a pair of vision cameras 130 at both ends. These vision cameras 130 provide mounting position information to verify the installation location of the glass.

The jig frame 300 is a frame that can be retracted by the emergency avoidance unit, which will be described later. The jig frame 300 may be spaced apart from the mounting frame 100.

In other words, the jig frame 300 is a separate frame independent of the mounting frame 100 and may be positioned at a predetermined distance in front of the mounting frame 100. The suction holder 510 and pressing presser 530, described later, may be installed on this jig frame 300.

Additionally, the jig frame 300 is not fixed in position while being spaced from the mounting frame 100; instead, it is movable so that the spacing distance from the mounting frame 100 can be adjusted.

As described later, the jig frame 300 is supported by an avoidance driving cylinder 710 installed on the mounting frame 100. The jig frame 300 moves closer to the mounting frame 100 when the avoidance driving cylinder 710 operates and returns to its original position when separated from the mounting frame 100.

The jig frame 300 may have a structure in which a cylinder rod 713 of the avoidance driving cylinder 710 is coupled at the center, and multiple suction holders 510 and pressing pressers 530 are evenly arranged in the front, rear, left, and right.

For example, as illustrated in the drawings, the jig frame 300 may have a roughly rectangular shape with a longer horizontal length compared to the vertical length to match the shape of the glass G.

The suction holder 510 is provided on the frame unit and, specifically, may be installed on the jig frame 300 to vacuum-suction and hold the glass G that will be mounted on the vehicle body C.

The suction holder 510 may include a vacuum pressure supply unit (not shown) that provides vacuum pressure and a vacuum suction pad 511 that substantially suctions the glass G under the vacuum pressure. The vacuum suction pad 511 may be supported by a spring element 513 to provide a certain buffering force.

The suction holders 510 are arranged in multiple units on the jig frame 300 to ensure stable suction and holding of the glass G.

For example, as illustrated in the drawings, four suction holders 510 may be installed at the four corner positions of the jig frame 300 to suction the glass G at four points.

The pressing presser 530 applies pressing force to the glass G held by the suction holder 510 to mount it onto the vehicle body C.

The pressing presser 530 includes a pressing cylinder 531 that provides pressing force and a pressing pusher 533 that applies the force to the glass G.

The pressing presser 530 is arranged in multiple units on the jig frame 300 to ensure even application of pressing force over the entire edge of the glass G.

For example, as illustrated in the drawings, four pressing pressers 530 may be supported by brackets on the left and right ends of the jig frame 300, extending outward, and two additional pressing pressers 530 may be positioned inward relative to the center of the jig frame 300, making a total of six.

The multiple pressing pressers 530 arranged in this manner ensure that the four pressing pressers 530 positioned at the outer front, rear, left, and right of the jig frame 300 press against the curved edges of the glass G, while the two pressing pressers 530 positioned inside the jig frame 300 press against the center of the glass G. This configuration allows uniform pressing force to be applied across the entire perimeter of the glass G.

As described above, the pressing presser 530 may be installed on the jig frame 300, but this is not limited thereto. Depending on the embodiment, a separate support section may be formed on the mounting frame 100 to install the pressing presser 530 on the mounting frame 100.

The suction holder 510, which vacuum-suctions the glass G, and the pressing presser 530, which applies pressing force to secure the glass G, are widely known in the relevant technical field. Therefore, a more detailed explanation of their configuration and operation is omitted.

The emergency avoidance unit functions to immediately move the glass G, which is held by the suction holder 510, outside the collision range with the vehicle body C when a malfunction occurs in the robot R, thereby preventing a collision between the glass G and the vehicle body C.

Specifically, if a malfunction occurs in a normally operating robot R, the vehicle body C will continue moving a certain distance in the transport direction due to inertia, as described later. In this case, the emergency avoidance unit retracts the glass G outside the collision range of the vehicle body C, i.e., beyond the movement range of the vehicle body C, thereby preventing a collision.

This emergency avoidance of the glass G can be achieved by moving the jig frame 300 a predetermined distance toward the mounting frame 100.

In other words, if a malfunction occurs in the normally operating robot R, the emergency avoidance unit moves the jig frame 300 a predetermined distance toward the mounting frame 100, thereby avoiding a collision involving the glass G.

That is, when the jig frame 300 is retracted a predetermined distance toward the mounting frame 100 by the emergency avoidance unit, the suction holder 510 installed on the jig frame 300 and the glass G held by it are also moved in the same manner, retracting from their original position toward the mounting frame 100. Consequently, the glass G is immediately moved outside the collision range of the vehicle body C, effectively preventing a potential collision between the glass G and the vehicle body C in the event of a robot R malfunction.

The emergency avoidance unit, which performs the function of avoiding a collision involving the glass G as described above, may include an avoidance driving cylinder 710, a movement guider 730, a robot detection unit 750, and an avoidance operation control unit 770.

The avoidance driving cylinder 710 is fixedly installed on the mounting frame 100 and supports the jig frame 300 in a manner that allows movement.

Specifically, the cylinder body 711 of the avoidance driving cylinder 710 is fixedly installed on the mounting frame 100, while the cylinder rod 713 is coupled to the center of the jig frame 300.

Accordingly, depending on the operation of the avoidance driving cylinder 710, the jig frame 300 can be retracted toward the mounting frame 100 for proximity movement or returned to its original position by moving away from the mounting frame 100.

The movement guider 730 helps guide the movement path of the jig frame 300 when it is moved by the avoidance driving cylinder 710, ensuring smooth movement in a straight-line path without shaking or twisting.

The movement guider 730 may be composed of multiple guide rods arranged around the avoidance driving cylinder 710.

The robot detection unit 750 detects whether a malfunction has occurred in the robot R and provides detection information to the avoidance operation control unit 770.

Here, the term “malfunction” of the robot R refers to any state in which the robot R is not operating normally. This is not limited to specific situations but may include various unexpected conditions such as a robot R failure or a failure in the power supply line connected to the robot R, leading to an unintended operational halt.

In other words, a malfunction refers to a scenario where the robot R unexpectedly stops operating abnormally due to a failure in the robot R itself or an interruption in the power supply line to the robot R, despite not receiving a stop command.

The avoidance operation control unit 770, upon detecting a robot R malfunction from the robot detection unit 750, controls the operation of the avoidance driving cylinder 710 to move the jig frame 300 toward the mounting frame 100.

That is, during normal robot R operation, the jig frame 300 maintains its mounted position at a certain distance from the mounting frame 100. However, when a robot R malfunction occurs, the avoidance operation control unit 770 commands the avoidance driving cylinder 710 to retract the cylinder rod 713, thereby moving the jig frame 300 to a retracted avoidance position closer to the mounting frame 100.

Since the emergency avoidance unit operates in the event of a robot R malfunction, it may include a dedicated power supply unit (not shown in the drawings) that independently provides power to the emergency avoidance unit, separate from the power supply line of the robot R.

In other words, the emergency avoidance unit performs its functions through a separately supplied power line that is independent of the operational power of the robot R.

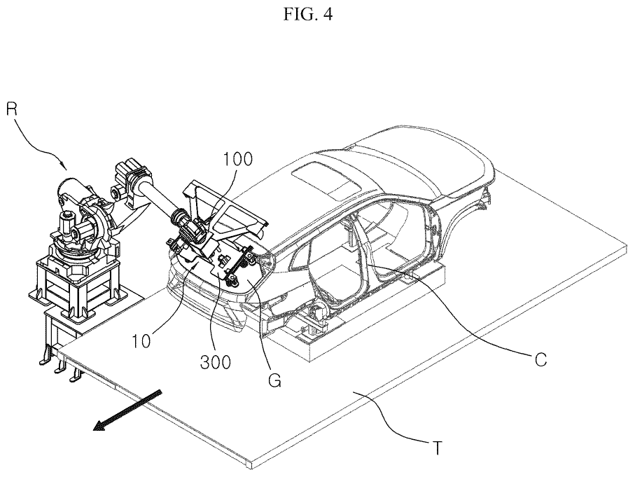

Having examined the structure of the vehicle glass mounting device 10 according to the present invention, we will now describe its operation with reference to FIGS. 4 to 8.

As illustrated in FIG. 4, the vehicle body C, which is the subject of glass mounting, enters the glass mounting process while mounted on a transport trolley T arranged in a continuous sequence. The glass mounting device 10 of the present invention is installed at the end of the arm of a robot R positioned on one side of the transport trolley T.

The transport trolley T carrying the vehicle body C typically moves at a speed of approximately 100 mm/s, transporting the vehicle body C. The robot R operates according to a pre-programmed control logic, tracking the speed of the vehicle body C and automatically mounting the glass G onto the glass mounting section of the vehicle body C.

In other words, from the perspective of the vehicle body C's movement direction, In the case of the robot positioned at the front, the mounting path for the glass G is in the opposite direction to the movement path of the vehicle body C. Therefore, the robot R's tracking arm operation is executed using a position control logic that subtracts position changes based on the transport speed of the vehicle body C.

Conversely, In the case of the robot positioned at the rear, the mounting path for the glass G is in the same direction to the movement path of the vehicle body C. Thus, the robot R's tracking arm operation is executed using a position control logic that adds position changes based on the transport speed of the vehicle body C.

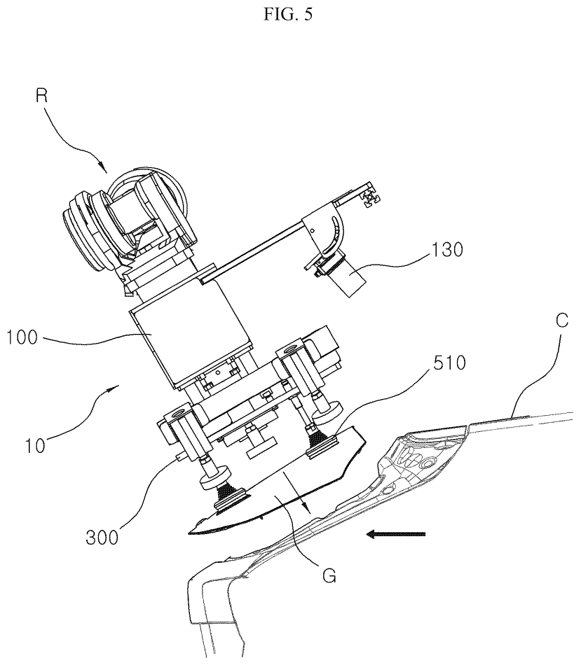

The glass mounting device 10 of the present invention is installed on the robot R arm, which tracks the position changes according to the transport speed of the vehicle body C. As illustrated in FIG. 5, the multiple suction holders 510 hold the glass G in place by vacuum suction, and as the robot R arm moves, the glass G makes contact with the glass mounting section of the vehicle body C. Then, the pressing presser 530 applies pressure to the glass G, thereby mounting it onto the glass mounting section of the vehicle body C.

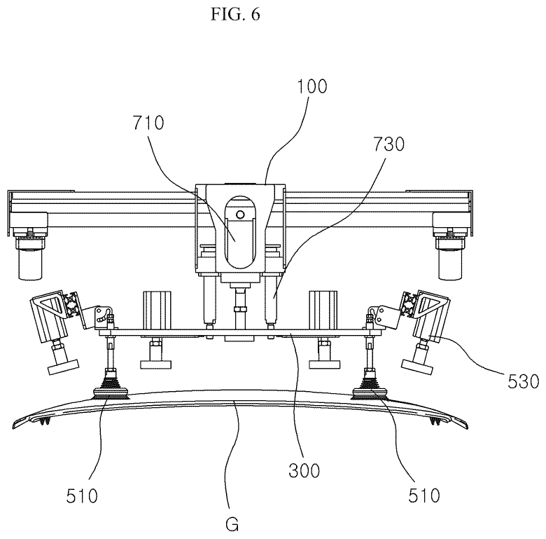

At this moment, as shown in FIG. 6, the avoidance driving cylinder 710 remains in a state where its cylinder rod 713 is extended, allowing the jig frame 300 to maintain a predetermined distance from the mounting frame 100.

However, if a malfunction suddenly occurs in the robot R while the vehicle body C is being transported at a constant speed, meaning that the robot R breaks down or the power supply to the robot R fails, the robot R may unexpectedly stop operating.

When such an unexpected stop of the robot R occurs, the main control system managing the assembly line may cut off the transport power supplied to the transport trolley T to bring the transport trolley T to an emergency stop.

However, even if the transport power to the transport trolley T is cut off, the transport trolley T, which carries a heavy load, will not stop immediately but will continue moving a certain distance due to inertia.

Therefore, if a robot R malfunction occurs while the glass G is in the process of being mounted, and the glass G remains within the movement range of the vehicle body C, the glass G and the vehicle body C may collide, presenting a critical problem.

That is, while the robot R immediately stops operating in the event of a malfunction, the transport trolley T and the vehicle body C mounted on it will continue moving a certain distance due to inertia, even if transport power is cut off. In other words, a braking distance is inevitable.

Therefore, particularly in the case of the front-side robot R, where the movement direction of the glass G is opposite to that of the vehicle body C, there is a high risk of a collision between the glass G and the vehicle body C.

To address this issue, the present invention operates the emergency avoidance unit in the event of a robot R malfunction, allowing the glass G to be immediately retracted outside the collision range of the vehicle body C, thereby effectively preventing a collision.

Specifically, when a malfunction occurs in the robot R, the robot detection unit 750 detects the malfunction and sends detection information to the avoidance operation control unit 770.

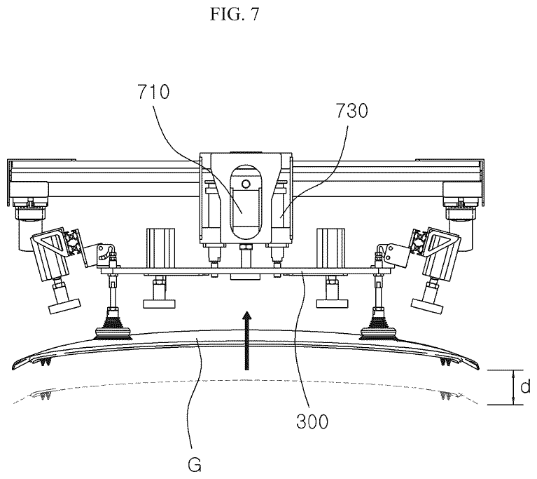

Then, as illustrated in FIG. 7, the avoidance operation control unit 770 controls the operation of the avoidance driving cylinder 710 to retract the jig frame 300 toward the mounting frame 100.

When the jig frame 300 moves toward the mounting frame 100 due to the activation of the emergency avoidance unit, the glass G held by the suction holders 510 also moves the same predetermined distance (d) from its original position toward the mounting frame 100.

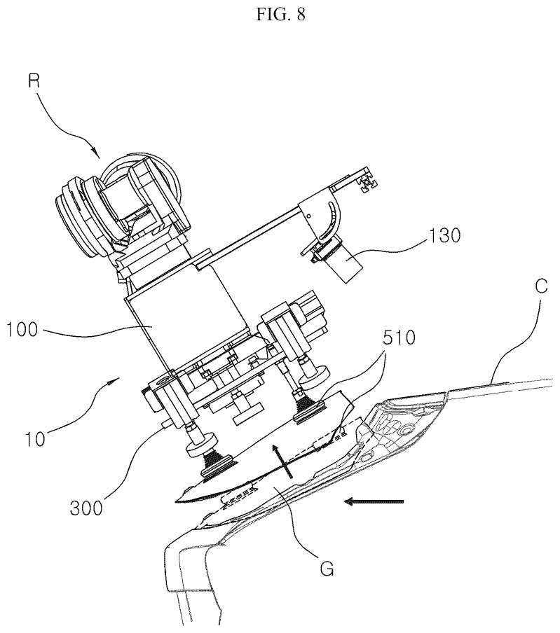

As a result, as illustrated in FIG. 8, the glass G is moved outside the movement range of the vehicle body C due to inertia, effectively preventing a collision between the glass G and the vehicle body C even in the event of a robot R malfunction.

The above has been a detailed description of the preferred embodiment of the present invention. However, the technical scope of the present invention is not limited to the embodiments and drawings described above. Modifications or equivalent configurations made by those skilled in the art without departing from the technical spirit of the present invention shall also be considered within the technical scope of the invention.

1. A glass mounting device comprising:
a frame unit to be coupled to an end of an arm of a robot for installing a glass for a vehicle;
a plurality of suction holders provided on the frame unit, the plurality of suction holders configured to vacuum-suction and hold the glass;
a robot detection unit configured to detect whether a malfunction has occurred in the robot; and
an emergency avoidance unit configured to move the glass, which is suctioned by the suction holders, outside a collision range with a body of the vehicle to prevent a collision when the malfunction occurs in the robot.

2. The glass mounting device of claim 1, wherein:
the frame unit includes a mounting frame fixedly coupled to the end of the arm of the robot and a jig frame spaced apart from the mounting frame and configured to be capable of retracting toward the mounting frame;
the plurality of suction holders are installed on the jig frame; and
the emergency avoidance unit is configured to move the jig frame a predetermined distance toward the mounting frame when the malfunction occurs in the robot.

3. The vehicle glass mounting device of claim 1, wherein the emergency avoidance unit comprises:
an avoidance driving cylinder fixedly installed on the mounting frame and movably supporting the jig frame; and
an avoidance operation control unit configured to control an operation of the avoidance driving cylinder to move the jig frame a predetermined distance toward the mounting frame when the robot detection unit detects the malfunction.

4. A glass mounting system comprising:
the robot;
the glass mounting device of claim 1.
